(19) United States
(12) Patent Application Publication
(10) Pub. No.: US 2004/0237394 A1
(43) Pub. Date: Dec. 2, 2004

(54) Low-cost system and method for the precision application of agricultural products

(76) Inventors: Ted E. Mayfield, Ukiah, CA (US); John B. Solie, Stillwater, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(21) Appl. No.: 10/839,621

(22) Filed: May 5, 2004

Related U.S. Application Data
(63) Continuation-in-part of application No. 10/801,757, filed on Mar. 16, 2004.
Application No. 10/801,757 is a continuation-in-part of application No. 10/195,138, filed on Jul. 12, 2002.
Application No. 10/195,138 is a continuation-in-part of application No. 09/911,867, filed on Jul. 24, 2001, now Pat. No. 6,601,341.

(51) Int. Cl. A01C 1/00

(52) U.S. Cl. 47/58.1 FV

(57) ABSTRACT

A method for in-season nutrient application which includes the steps of: determining a nutrient response index for a field; measuring the normalized difference vegetation index (NDVI) of a plurality of noncontiguous areas within an area; determining an average rate of application of the nutrient as indicated by the measured areas; and applying the nutrient to a second nearby area at the indicated rate.

### CROSS REFERENCE TO RELATED APPLICATION

This application is a continuation-in-part of co-pending U.S. patent application Ser. No. 10/801,757, filed Mar. 16, 2004, which is a continuation-in-part of copending U.S. patent application Ser. No. 10/195,138, filed Jul. 12, 2002, which is a continuation-in-part of U.S. patent application Ser. No. 09/911,867, filed Jul. 24, 2001, now U.S. Pat. No. 6,601,341, all such referenced applications and patents being incorporated herein by reference.

### BACKGROUND OF THE INVENTION

1. Field of the Invention:

This invention relates generally to a method for determining a rate of application of agricultural products. More particularly, but not by way of limitation, the present invention relates a method for determining a rate of application of an agricultural product to a crop.

2. Background:

“Precision farming” is a term used to describe the management of intrafield variations in soil and crop conditions. “Site specific farming”, “prescription farming”, and “variable rate application technology” are sometimes used synonymously with precision farming to describe the tailoring of soil and crop management to the conditions at discrete, usually contiguous, locations throughout a field. The size of each location depends on a variety of factors, such as the particular crop, the type of operation performed, the type of equipment used, the resolution of the equipment, as well as a host of other factors. Generally speaking, the smaller the location size, or plot, the greater the benefits of precision farming, at least to areas of approximately one-half square meter.

Typical precision farming techniques include: varying the planting density of individual plants based on the ability of the soil to support growth of the plants; and the selective application of farming products such as herbicides, insecticides, and, of particular interest, fertilizer.

In contrast to precision farming, the most common farming practice is to apply a product to an entire field at a constant rate of application. For example, nutrient application rates are often based on a predicted crop yield. The rate of application is selected to maximize crop yield over the entire field. Unfortunately, it would be the exception rather than the rule that all areas of a field have consistent soil conditions and consistent crop conditions. Accordingly, this practice typically results in over application of product over a portion of the field, which wastes money and may actually reduce crop yield, while also resulting in under application of product over other portions of the field, which may also reduce crop yield.

Perhaps even a greater problem with conventional methods is the potential to damage the environment through the over application of chemicals. Excess chemicals, indiscriminately applied to a field, ultimately find their way into the atmosphere, ponds, streams, rivers, and even the aquifer. These chemicals pose a serious threat to water sources, often killing marine life, causing severe increases in algae growth, leading to eutrophication, and contaminating potable water supplies.

From the early 1950's through the early 1970's, increased food production was a priority in agricultural circles around the world. During this period it was noted that nitrogen fertilizer had the single largest impact on yield and, as a result, the largest increase in the use of agricultural inputs has been nitrogen. Although fertilizer nitrogen consumption and grain production have both increased over the last five decades, contamination of surface water and ground water supplies continues because the efficiency at which fertilizer nitrogen is used has remained at a stagnant, and dismal, 33%, worldwide. While the unaccounted for nitrogen (67% of applied fertilizer nitrogen) has been well documented, heretofore, there has been no significant improvement on the inefficiency at which nitrogen is used in cereal production.

Thus it can be seen that there are at least three advantages to implementing precision farming practices. First, precision farming has the potential to increase crop yields, which will result in greater profits for the farmer. Second, precision farming may lower the application rates of seeds, herbicides, pesticides, and fertilizer, reducing a farmer's expense in producing a crop. Finally, precision farming will protect the environment by reducing the amount of excess chemicals applied to a field, which may ultimately end up in a pond, stream, river, and/or other water source.

Predominately, precision farming is accomplished by either: 1) storing a prescription map of a field wherein predetermined application rates for each location are stored for later use; or 2) by setting application rates based on real-time measurements of crop and/or soil conditions. In the first method, a global positioning system (GPS) receiver, or its equivalent, is placed on a vehicle. As the vehicle moves through the field, application rates taken from the prescription map are used to adjust variable rate application devices such as spray nozzles. A number of difficulties are associated with the use of such a system, for example: due to the offset between the GPS receiver and the application device, the system must know the exact attitude of the vehicle in order to calculate the precise location of each application device, making it difficult to achieve a desirable location size; soil and plant conditions must be determined and a prescription developed and input prior to entering the field; and resolving a position with the requisite degree of accuracy requires relatively expensive equipment.

In the latter method, a sensor is used to detect particular soil and plant conditions as the application equipment is driven through the field. The output of the sensor is then used to calculate application rates and adjust a variable rate application device in real time. Since the physical relationship between the sensor and the application device is fixed, the problems associated with positional based systems (i.e., GPS) are overcome. In addition, the need to collect crop data prior to entering the field is eliminated, as is the need for a prescription map.

With either technique, there is a need to sense the soil and/or crop conditions in order to determine a rate of application of a given farm product. With regard to soil analysis, attempting to analyze the soil condition by way of a soil sample at each site would be time consuming and the handling of individual samples would be a logistical nightmare. Even with in-field analysis, the task would be daunting, at best.

Co-pending U.S. patent application Ser. No. 10/195,138, filed by Raun, et al., which is incorporated herein by reference, describes a method for determining in-season macro and micronutrient application based on predicted yield potential and a nutrient response index. With the method of Raun, et al., remote sensing may be employed to determine plant need for a particular nutrient and to determine mid-season yield potential. An optical sensor is used to measure the reflectance of a target plant at one or more wavelengths of light and, based on known reflectance properties of the target, an output is provided which is indicative of the need for the nutrient. The specific need is determined from a response index for the field, which is calculated by scanning a nutrient rich reference strip and a reference strip fertilized according to the common practice for the field. It has been found that the method of Raun, et al. provides increased yield with overall lower fertilizer application rates with plot sizes as small as 0.4 square meters.

It has also been found that further improvements in application rates can be obtained by measuring the coefficient of variation over each site, and adjusting application rates for a site in light of the variability of biomass over the site. A method for using the coefficient of variation to improve nutrient application rates is disclosed in co-pending U.S. patent application Ser. No. 10/801,757, entitled “Use of Within-Field-Element-Size CV for Improved Nutrient Fertilization in Crop Production”.

These methods have proven effective in reducing nutrient application rates while increasing yield. In a typical system, these methods are practiced by placing optical sensors along a boom which is passed over a crop row. The distance between sensors determines the width of the sites. Achieving the desired resolution requires a relatively large number of individual sensors. While the cost of these systems will be recovered through improved nutrient efficiency and greater yields in just a few growing seasons, they may still be cost prohibitive to many small and midsized farming operations.

Thus it is an object of the present invention to provide a low-cost system and method for performing precision farming techniques.

### SUMMARY OF THE INVENTION

The present invention provides a method for practicing precision farming techniques in the application of products such as fertilizer, pesticides, herbicides or other farming chemicals or biological farming materials. For convenience, all such substances whether, biological or non-biological, organic or inorganic, should be considered encompassed by the term “agrochemical”. Like present precision farming techniques, in a preferred embodiment crop or soil characteristics are sensed over a plurality of relatively small areas, preferably on the order of one square meter. These measurements are used to estimate application rates on adjacent areas, which may be much larger in area. Application of agrochemicals to the adjacent areas can then be performed by readily available variable rate sprayers.

In contrast to prior techniques, in the present method sensed plots are not necessarily contiguous and less than the entire area to be sprayed is actually sensed. While individual plot measurements have too much variability to be an accurate predictor of nearby plots, it has been found that the average or other smoothed combination of several plots does provide a good estimate of the needs of nearby plots. Thus, the characteristics measured in sensed plots can be statistically combined and used to estimate the requirements of nearby plots. As a result, the number of sensors employed in scanning a field is dramatically reduced, without sacrificing plot size, thus leading to a corresponding reduction in the cost of the sensing equipment.

Efficiency of site-specific nutrient management is largely determined by how well small-scale spatial variability is managed and the time when fertilizers are applied. As will be appreciated by those skilled in the art, ideally a plot size is selected such that the plot represents the smallest area over which variations in nutrient availability measurably impact plant condition. Thus plot-to-plot variations in the sensed characteristic are likely the result of nutrient stress while intraplot variations are more likely the result of factors other than nutrient stress. Thus, increasing the field-of-view of a sensor simply increases plot size which, in turn, reduces the benefits.

While the present invention is useful in the application of any number of various agrochemicals, the invention is explained primarily in the context of nutrient application. In a preferred embodiment of the inventive method, remote sensing is employed to determine plant need for a particular nutrient and to determine mid-season yield potential. Preferably an optical sensor is used to measure the reflectance of a target plant, or plants, within a particular plot, at one or more wavelengths of light and, based on known reflectance properties of the target; an output is provided which is indicative of the need for the nutrient. Intraplot sensor readings may also be taken to determine the coefficient of variation (“CV”) of plant condition within the plot. Where CV is high, the potential yield is adjusted downward to account for factors, which will limit production other than nutrient stress. The inventive process is applicable to crop nutrients whose projected need can be based on predicted removal of the nutrient derived from potential yield and the process is particularly well suited to the mid-season application of nitrogen and/or other nutrients where deficiencies can be corrected by mid-season applications.

It has also been found that nutrient availability tends to vary over a gradient and discontinuities are relatively uncommon. Accordingly, the nutrient requirements of a plot typically bear some relation to the nutrient requirements of nearby plots. Thus, the inventive method is performed by sensing plant characteristics indicative of a crop requirement in noncontiguous plots in an area, calculating an average application rate for the area, and applying the chemical to an adjacent area at the calculated rate.

In another preferred embodiment the present invention is adapted for use with existing variable rate spray equipment. Present systems require variable rate application equipment capable of delivering chemicals to a sensed area immediately after sensing. Such application equipment requires individually adjustable nozzles and must be quick to respond. In contrast, the inventive system uses the average of previously sensed areas to prescribe an application rate on the next area covered, significantly reducing the level of responsiveness required of the applicator. Thus, a farmer who already possesses such variable rate spray equipment can take advantage of improved precision farming techniques without a significant investment in new application equipment.

Further objects, features, and advantages of the present invention will be apparent to those skilled in the art upon examining the accompanying drawings and upon reading the following description of the preferred embodiments.

### BRIEF DESCRIPTION OF THE DRAWINGS

FIG. 1A provides a side view of a farming vehicle having multiple sensors and spray nozzles for use with the inventive method mounted thereon.

FIG. 1B provides a top view of the farming vehicle having a typical arrangement of sensors and spray nozzles for use with the inventive method mounted thereon.

FIG. 2 provides a top view of the farming vehicle while treating crops in a field.

### DETAILED DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

As will become apparent to those skilled in the art from the discussion hereinbelow, practice of the present invention potentially increases crop yield while reducing the total amount of agrochemicals, such as nitrogen, added to a crop. While the inventive method is applicable to virtually any crop, for purposes of example, and not by way of limitation, the description of the preferred embodiments is directed to production of winter wheat and the fertilization thereof. Further, while the inventive method is also applicable to virtually any scheme for practicing site-specific farming, for purposes of illustration, and not by way of limitation, preferred embodiments are described with reference to the systems and techniques disclosed in co-pending U.S. patent application Ser. No. 10/195,138, entitled “Process for In-Season Fertilizer Nutrient Application Based on Predicted Yield Potential,” and U.S. patent application Ser. No. 10/801,757, entitled “Use of Within-Field-Element-Size CV for Improved Nutrient Fertilization in Crop Production,” which were incorporated herein by reference, supra.

For the purpose of determining the responsiveness of a crop to a nutrient, in practice, side-by-side reference plots are planted. For purposes of specificity in the text that follows, it will be assumed that these plots take the form of strips of plants that are planted near the actual crop, although other patterns and shapes are certainly possible. A first reference strip is preferably planted in accordance with the common practice in the field and a second strip is fertilized such that a particular nutrient is not limiting to the plant production. The response of the crop to the nutrient can then be determined, as quantified in a response index, by comparison of the reference strips.

In-season measurements are then made of crop biomass on a site-by-site basis to determine a yield potential. While individual sites represent only a small percentage of the area actually treated, a sufficient number of sites are measured within a area to provide a reasonable average of the nutrient requirements for that area. A potential yield with added nutrient can then be calculated by multiplying the area yield potential by the response index, where the extrapolated yield is capped at a maximum yield for the crop in light of the growing environment. Optionally, multiple measurements are made over each site and a coefficient of variation (“CV”) is calculated for each site and used to modify the response index for the area to account for factors which will limit the potential yield with added nutrient other than nutrient stress.

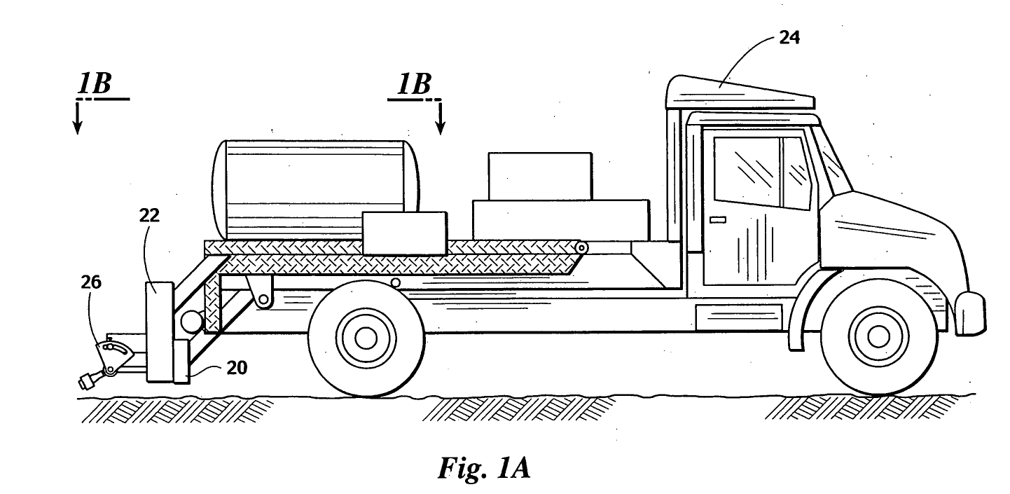

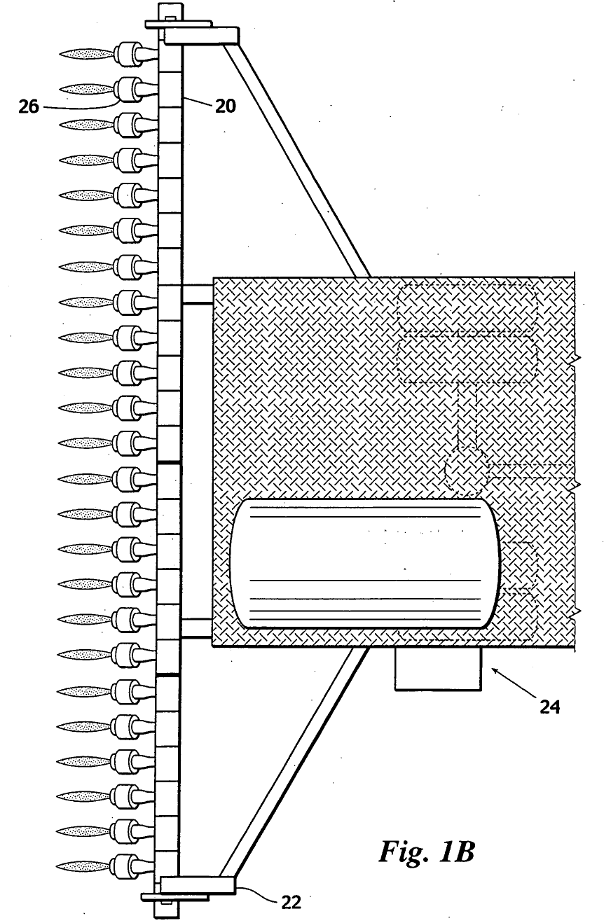

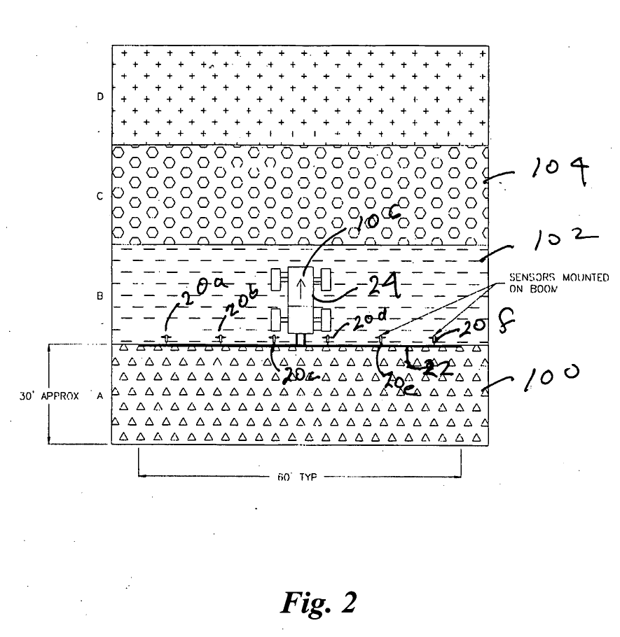

Referring now to the drawings, wherein like reference numerals indicate the same parts throughout the several views, a preferred embodiment of the inventive method is incorporated in the fertilizer spreading vehicle 24 shown in FIGS. 1A and 1B. Preferably, a plurality of sensors, of which sensor 20a is representative, are disposed along boom 22 at approximately equal spacing. Typically, boom 22 extends laterally from vehicle 24. Spray nozzles, of which nozzle 26 is representative, are also disposed along boom 22. With further reference to FIG. 2, as vehicle 24 travels along a crop row, boom 22 projects over the plants such that each sensor 20a-f measures the reflectance of plants in its immediate view. The system then determines the extent to which fertilizer is needed as a statistical compilation of plots sensed both across boom 22 and along the direction of travel of vehicle 24, and such controls the rate of application of a nutrient through nozzles 26 as an adjacent area is traversed.

It should be noted that a number of different scanning techniques can be employed to sense plant conditions in conjunction with the inventive method. Such scanning techniques are well known in the art and are presently in use. In the preferred embodiment reflectance sensors are employed which produce a modulated light beam at discrete wavelengths of light and employ photodetectors to measure the reflected light at each wavelength. The term “active reflectance sensor” is used to describe such devices. Alternatively passive sensors which use ambient light to measure reflectance and/or handheld sensors can be used to perform the present invention. One sensor suitable for use with the present invention is the sensor described in U.S. Pat. No. 6,596,996 B1 entitled “Optical Spectral Reflectance Sensor and Controller” which is incorporated herein by reference.

In a typical embodiment of the present invention, reflectance sensors are used to measure an index indicative of biomass. By way of example and not limitation, one such index is the normalized difference vegetation index (“NDVI”), which provides an estimate of the biomass of the plant at the time of measurement. NDVI, in light of growing days (days when the plant is actively growing), is highly correlated with the condition of a plant stand, and hence, with the expected yield. While NDVI is the preferred vegetative index, other vegetative indices can alternatively be used to estimate plant biomass and expected yield.

One method of determining NDVI is through the scanning of a plant, or group of plants, to determine the reflectance of the plant at red light having a wavelength of approximately 660 nanometers and the reflectance of the plant at near infrared light having a wavelength of approximately 780 nanometers. NDVI is then calculated as follows:

NDVI=(NIR−red)/(NIR+red)

where “NIR” is reflectance at near infrared light and “red” is the reflectance value at red light. It should be noted that NDVI is a dimensionless value. Other wavelengths can be used to calculate these indices and may be preferred for particular crops. It should be noted that a microprocessor, or other computing device, may be included in a sensor to perform the calculation of NDVI within the sensor.

In addition to determining NDVI for a particular plot, the coefficient of variation (CV) may also determined by performing several measurements of NDVI within a plot to determine the standard deviation and mean within the plot. CV, given in percentage, is calculated by:

CV=(Standard Deviation/Mean)*100

Prior to application of the topdress fertilizer the number of growing days since planting (GDP) is preferably determined. “GDP” is defined as the number of days in which the plant is actively growing. A growing day is one where the average temperature, e.g., where (Tₘᵢₙ+Tₘₐₓ)/2, is greater than 4.4 degrees Celsius such that GDP is adjusted to exclude days where ambient temperatures too low for active growth of the crop. This information is readily available in virtually any agricultural area. Typically, growing days are tracked by government agencies, universities, large farming operations, and the like. It should be noted that the inventive method may also use growing days since emergence in lieu of growing days since planting. For certain crops cumulative time and heat units in the form of growing degree days (GDD) may be used instead of GDP.

Assuming GDP is greater than zero, the in-season estimated yield index (INSEY) is preferably calculated as follows:

INSEY=NDVI/GDP

It should be noted that INSEY can be thought of as an estimation of biomass per growing day. As such, INSEY is independent of the precise time of measurement since days from planting acts as a normalizing divisor.

Next, the potential yield level (YP₀) with no added nutrient will preferably be calculated as follows:

YP₀=0.359e^{(324.4*INSEY)}(YP₀ in Mg/ha)

It should be noted that the coefficients of the above equation were empirically obtained for winter wheat. While the general form of the equation is generally valid for other crops, the coefficients may vary from crop-to-crop.

Typically, when the inventive method is used with wheat, reflectance readings are collected between 80 and 150 days after planting. This coincides generally with plant growth between Feekes physiological growth stage 4 wherein leaf sheaths are beginning to lengthen, and stage 6 wherein the first node of the stem is visible.

Identifying a specific yield potential does not translate directly to a nutrient recommendation. Determining the extent to which the crop will respond to additional nutrient is equally important. Thus, as a preliminary matter, a nutrient response index (RI) for the field is preferably determined. The pre-plant non-limiting, or nutrient rich, strip was established in each field at, or near, planting time. Regardless of the particular fertilization practice employed by a farmer, the non-limiting strip can be used to determine the likelihood of obtaining an in-season response to a nutrient, such as nitrogen, specifically tailored to that particular farmer's practice. Prior to applying topdress nitrogen, the non-limiting strip will be scanned to determine NDVI, as will be the parallel strip fertilized according to the conventional practice of the farmer. Measurements are paired spatially. The response index may then be calculated as:

RI_{NDVI}=NDVI from the non-limiting strip/NDVI from the farmer practice strip.

Other methods of determining a response index may alternatively be employed.

The highest NDVI measurement along the nitrogen-rich strip can be used to calculate the maximum potential yield (YPₘₐₓ), the maximum yield that could be expected within the most productive area in a field where nitrogen is not limiting for the crop season in measurement.

Next, the predicted maximum potential yield with added nutrient X (YPₓ) is preferably calculated as:

YPₓ=YP₀*RI(YPₓ in kg/ha)

It should be noted that two limits are preferably imposed on this calculation, namely: 1) RI_{NDVI} cannot exceed 3.0; and 2) YP_{N} cannot exceed YPₘₐₓ where YPₘₐₓ is the biological maximum for a specific crop, grown within a specific region or in the specific field, and under defined management practices. The value of 3.0 for maximum RI may vary for a specific crop, grown in a specific region under different conditions.

If CV is measured, the variability within each sensed and treated area can be used to adjust the response index of the area to account for factors which will limit production other than nutrient stress. The relationship between the response index and the coefficient of variation for winter wheat is preferably given by:

RI_{CV}=RI_{CV0}*(−0.01219*CV+1)

where RI_{CV0} is the response index when CV is equal to 0.

A preferred generalized approach can then be used to calculate the yield potential for a sensed site as follows:

YP_{CV}=RI_{CV}*YP₀

RI_{CV} is derived from RI_{NDVI}, RI_{YP}, or any other response index operative to predict increased yield with additional fertilizer.

After an obtainable yield is determined, the predicted percent of nutrient X in the grain (PXG) is preferably obtained from known averages in a specific crop type. It should be noted that “crop type” refers to a particular type of grain, rather than a species of grain, i.e., winter wheat, spring wheat, hard red, soft red, hybrid corn, sorghum, rice, etc. PXG is multiplied by YP_{X} to obtain the mass (in kg) of X nutrient taken up in the grain. The average percent of a particular nutrient in a specific grain may be adjusted for regional variations.

Next, the predicted grain nutrient uptake (GXUP) at YPₓ and YP₀ are calculated:

GXUP_{YPX}=PXG*YP_{X} kg/ha

GXUP_{YP0}=PXG*YP₀ kg/ha

From these values, the in-season topdress fertilizer nutrient X requirement (FXR) is given by:

FXR=(GXUP_{YPX}−GXUP_{YP0})/EFF_{X}

where EFF_{X} is the maximum nutrient use efficiency of an in-season application of nutrient X in the manner applied. EFF_{X} via in-season application for most required plant nutrients is approximately 0.7. EFF_{P} is known to be approximately 0.5 for topdress phosphorus. EFF_{X} may be adjusted for other factors.

With reference to FIG. 2, each sensor 20a-f makes successive measurements as tractor 24 traverses area 100 of a particular and preferably predetermined length, preferably on the order of thirty feet, in the direction indicated by arrow 106. Alternatively, measurements may be taken over predetermined time periods to define an area. Application rates calculated over area 100 are then averaged or otherwise combined to create a prescription for area 102. As area 102 is treated based on measurements from area 100, the sensors calculate the prescription for the next area 104. This process repeats for the entire field. As will be apparent to those skilled in the art, as variations in the field cause varying nutrient requirements, the inventive method will adjust the rate of application of the nutrient.

It should be further noted that while the discussion of preferred embodiment is provided with regard to using the inventive method to improve the efficiency of farming cereal grain crops, in particular winter wheat, the inventive method has far broader application and is useful for improving the growth of virtually any plant, including, for example, turf, flowers, and trees. While the particular equations used in the calculation of application rates may vary somewhat between various types of plants, the steps to arrive at the required application rate are the same. In circumstances where attaining a maximum yield is not of primary interest, but where plants are managed to attain other desired attributes, such as, for example, color in the case of flowers, the vegetative index, which may be based upon an empirically derived constant, would be applicable to such attribute, and it may not be necessary to use a nutrient response index in calculating the application rate.

In connection with the preferred embodiment of the present invention each sensor senses an area approximately 2 ft by 18 to 30 feet depending on the vehicle speed. For certain applications, it may be preferable to vary the sensed area to other dimensions. In row crops, i.e. corn, sorghum, etc., it may be preferable to sense plants on a plant-by-plant basis rather than using a fixed area. Thus, a plot may represent a group of plants within a fixed area, an individual plant stand, or a series of plant arrayed linearly in a row.

As will be apparent to those skilled in the art, the inventive method is well suited for incorporation into a software program for execution by a microprocessor or other computing device. When combined with a reflectance sensor as described hereinabove, the inventive method is ideally suited for use in a system which measures reflectance, calculates the requirements for a given nutrient and controls the variable rate applicator. In such a system, the calculations detailed hereinabove may be reduced to one or more computer programs stored on a computer readable storage device. Preferably, the program will be arranged in a modular fashion such that individual modules are responsible for each calculation and each control function.

Additionally, it should be noted and remembered that when the term “average” is used herein, that term should be broadly construed to include any measure of central tendency such as, without limitation, means, medians, modes, weighted means (including means that are weighted inversely proportional to the coefficient of variation), spatially weighted means, etc. Further, in those instances wherein an “average” value is calculated over a plurality of different areas, that term should be broadly interpreted to be a single numerical value that is representative of such areas (e.g., in the instance where the mean, median, etc., are to be calculated), or, alternatively if the situation calls for it, interpreted to be a continuous (or near-continuous) spatially varying function that is determined, e.g., by interpolation, extrapolation, curve fitting, trend surface analysis, kriging, etc., and can be used to estimate functional values away from the locations where measurements were taken.

Further, those of ordinary skill in the art will recognize that although the preferred embodiment utilizes measurements in a single area to estimate the nutrient application rate that is to be applied in one or more adjacent areas, it is possible that in some circumstances multiple areas might be combined to form this estimate. For example, consider the case where measurements in Area 1 determine the application rate in Area 2, and then the combined estimates from Area 1 and Area 2 are used to determine the application rate in Area 3, and so on.

Still further, it should be appreciated that the average may be taken on either the input or output side of the process; meaning that, for example, the average vegetative index of the sensed plots might be utilized in determining an application rate for unmeasured contiguous areas, or, alternatively, an average of calculated application rates might instead be utilized.

Finally, it should also be noted that, while farming applications of the inventive method were discussed in relation to the preferred embodiment, the invention is not so limited. The inventive method could be used to improve the efficiency of the application of fertilizer in virtually any crop. While the constants in the equations given above may vary from crop-to-crop, the inventive method is otherwise applicable to virtually any type of plant and can be applied, with minor modification, to any crop nutrient whose projected need could be based on predicted uptake in the grain, as derived from predicted yield or YP₀. In addition, the inventive method is not limited to liquid fertilizers, but can also be used in the application of solid and gaseous forms. Accordingly, the terms “sprayer” and “nozzle” should be interpreted broadly to include applicators appropriate to the form of fertilizer selected.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A method for in-season nutrient application to a crop, wherein the crop has a known nutrient response index, including the steps of:
(a) sensing at least one value representative of a vegetation index for each of a plurality of noncontiguous areas in a first area;
(b) calculating said vegetation index for each of said noncontiguous areas using said at least one value;
(c) determining a rate of application of a nutrient in said first area using at least said nutrient response index and said vegetation index; and
(d) applying said nutrient at said rate of application to a second area in proximity to said first area.

2. The method for in-season nutrient application to a crop of claim 1 wherein said vegetation index is the normalized difference vegetation index for the crops within said plurality of areas.

3. The method for in-season nutrient application to a crop of claim 1 wherein said response index is determined by sensing a vegetation index in a reference strip and in a nutrient rich strip.

4. A method for in-season application of an agrochemical to a field of plants, including the steps of:
(a) sensing at least one value representative of a vegetation index for each of a plurality of noncontiguous areas in a first area;
(b) calculating said vegetation index for each of said noncontiguous areas using said at least one value;
(c) determining a rate of application of said agrochemical in said first area using said vegetation index; and
(d) applying said agrochemical at said rate of application to a second area in proximity to said first area.
